(19) United States
(12) Patent Application Publication
(10) Pub. No.: US 2025/0286945 A1
(43) Pub. Date: Sep. 11, 2025

(54) SYSTEM FOR MANAGING AND SWITCHING CONNECTIONS BETWEEN MULTIPLE WEARABLE DEVICES ASSOCIATED WITH A SINGLE MOBILE STATION INTERNATIONAL SUBSCRIBER DIRECTORY NUMBER

(71) Applicant: T-Mobile USA, Inc., Bellevue, WA (US)

(72) Inventor: Anjani Deepthi Nandigam, Bothell, WA (US)

(21) Appl. No.: 18/601,871

(22) Filed: Mar. 11, 2024

(51) Int. Cl. H04M 1/72412; H04M 1/72409; H04M 1/72436; H04M 1/72457

(52) U.S. Cl. CPC H04M 1/72412; H04M 1/724094; H04M 1/72436; H04M 1/72457

(57) ABSTRACT

Techniques related to managing connections between a mobile device and multiple wearable devices are disclosed. In one example aspect, a method for managing connections includes receiving a first request from a user to connect a first wearable device to a mobile device and connecting the first wearable device to the mobile device upon determining compatibility of the first wearable device with the mobile device. In response to receiving a second request from the user to connect a second wearable device to the mobile device, the first wearable device is disconnected from the mobile device and the second wearable device is connected to the mobile device.

### BACKGROUND

Wearable technology is any technology that is designed to be used while worn. Common types of wearable technology include smartwatches and smart glasses. Wearable devices such as activity trackers are an example of the Internet of Things since “things” such as electronics, software, sensors, and connectivity are effectors that enable objects to exchange data, including data quality, through the internet with a manufacturer, operator, and/or other connected devices without requiring human intervention. Wearable technology offers a wide range of possible uses, from communication and entertainment to improving health and fitness.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a block diagram that illustrates an overview of a system for managing connections between a mobile device and multiple wearable devices according to some implementations of the present technology.

FIG. 4 illustrates an example display of the mobile application according to an implementation of the present technology.

FIG. 5 is a flowchart representation of a system of managing connections between a mobile device and multiple wearable devices according to some implementations of the present technology.

FIG. 6 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The market for wearable technology has experienced rapid expansion in recent years. Because different wearable devices come in different colors and shapes and offer different features based on the needs of a wearer, it is common for an individual to own and wear multiple wearable devices. Prior to equipping a wearable device, an individual may establish connection between a mobile device and the wearable device to facilitate efficient communication of information between the devices. Because each wearable device may have different compatibility or connection requirements, however, there is currently no efficient way for an individual owning multiple wearable devices to manage connections among multiple wearable devices and a mobile device under a single mobile number plan.

The disclosed technologies address such common operational challenges faced by an individual owning multiple wearable devices by employing a framework that enables managing of multiple wearable devices associated with a single mobile number plan, also referred to as a mobile station international subscriber directory number (MSISDN). Each of the multiple wearable devices is associated with a unique identifier, such as an embedded-SIM (eSIM). Using the unique identifiers associated with the multiple wearable devices, the framework enables determining and managing connections between a mobile device associated with the single mobile number plan and the multiple wearable devices. The framework also enables determining compatibility of the multiple wearable devices with the mobile device.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

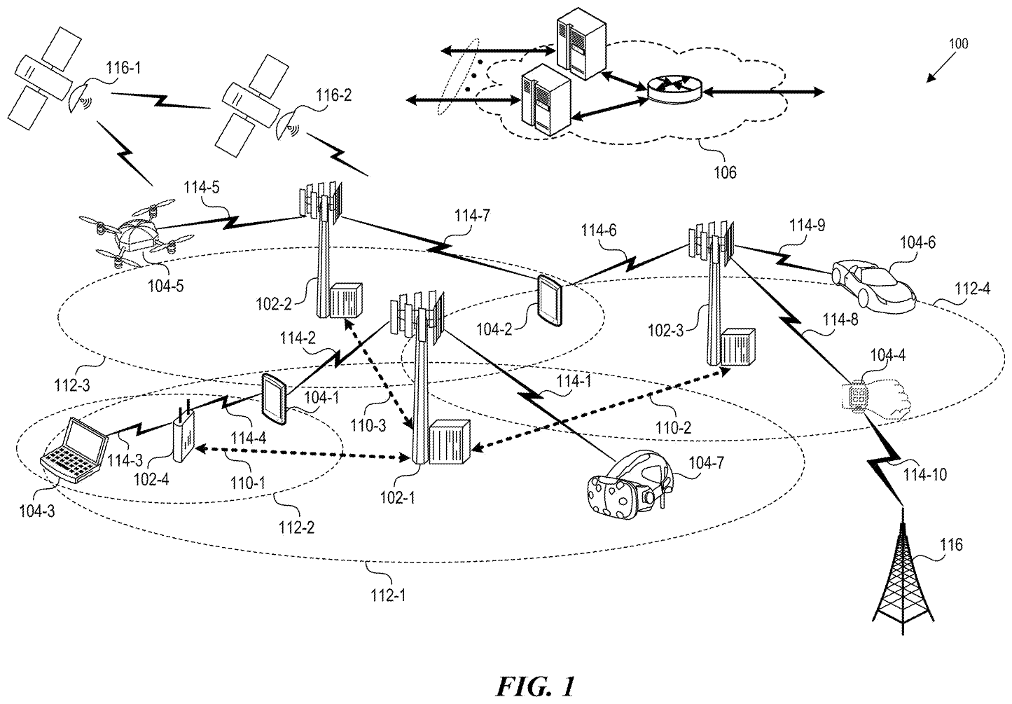

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QOS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

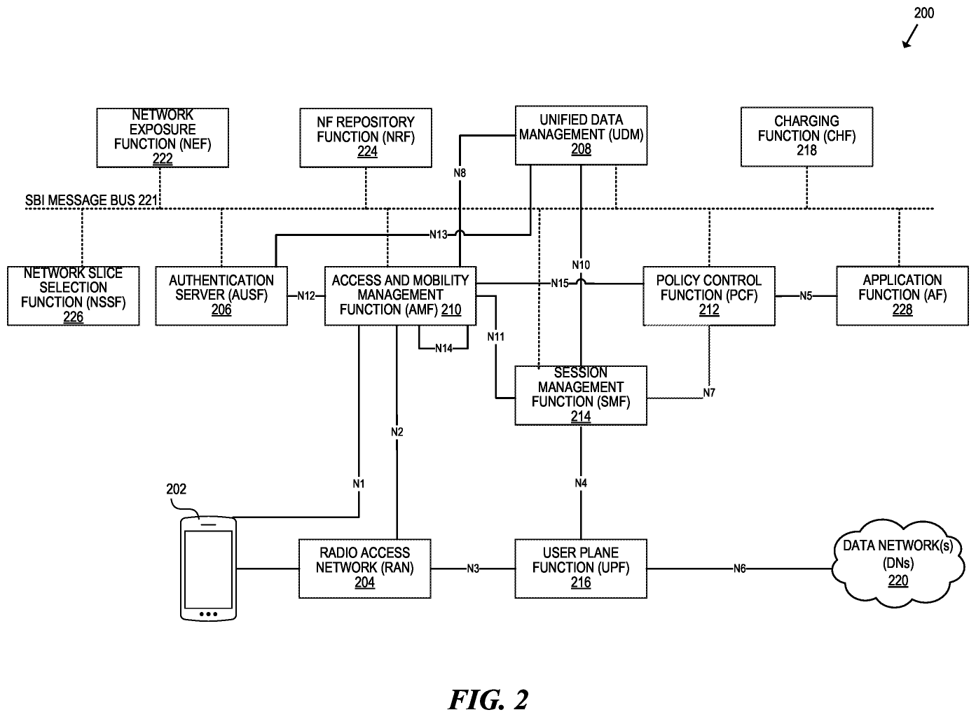

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

System for Managing and Switching Connections Between Multiple Wearable Devices Associated with a Single Mobile Station International Subscriber Directory Number

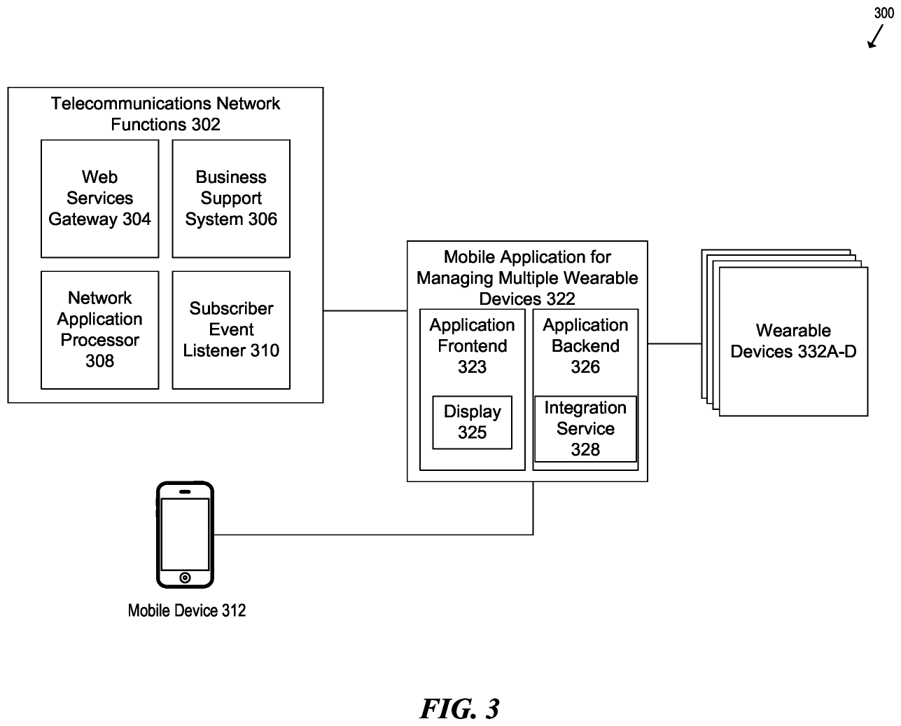

FIG. 3 is a block diagram that illustrates an overview of a system 300 for managing and switching connections between a mobile device and multiple wearable devices according to some implementations of the present technology. A mobile application 322 for managing multiple wearable devices 332A-D is configured to enable communication between a telecommunications network and a mobile device 312 associated with a unique mobile station international subscriber directory number (MSISDN). Each of the multiple wearable devices is associated with a unique identifier, such as an embedded-SIM (eSIM). Using the unique identifiers associated with the multiple wearable devices, the system 300 enables determining and managing connections between a mobile device associated with the single MSISDN and the multiple wearable devices.

The mobile application 322 is an application installed on the mobile device 312 and can include an application frontend 323 and an application backend 326. In some implementations, the mobile application 322 includes other components, such as a virtual assistant, to facilitate a user's experience while using the mobile application 322 to manage connections to the multiple wearable devices 332A-D. For example, the mobile application 322 can be integrated with virtual assistants such as Amazon Alexa or Apple Siri to receive voice commands from the user to manage connections between the mobile device 312 and the wearable devices 332A-D.

The mobile application 322 uses the display 325, which is part of an application frontend 323, to display information such as a list of the wearable devices 332A-D associated with the MSISDN, status of each of the wearable devices 332A-D, and/or compatibility information associated with each of the wearable devices 332A-D. The display 325 can also include multiple buttons that enable a user to send commands associated with the wearable devices 332A-D. The commands can include checking compatibility of the wearable devices 332A-D with the mobile device 312, determining a connection between the mobile device 312 and any one of the wearable devices 332A-D and disconnecting a currently connected wearable device from the mobile device 312. In some implementations, the display 325 includes indications or messages to update the user on the status of the commands. For example, in response to a user command to connect wearable device 332A to the mobile device 312, the display 325 displays a system message indicating successful connection.

The mobile application 322 includes the application backend 326. The application backend 326 includes data and operating syntax that allow the mobile application 322 to operate and perform switching of connections between the wearable devices 332A-D. Data stored can include a list of wearable devices 332A-D associated with the mobile device 312 and information pertaining to each of the wearable devices 332A-D, such as unique identifiers, e.g., eSIM or physical SIM associated with each of the wearable devices 332A-D and compatibility requirements for each of the wearable devices 332A-D.

Upon receiving a user command to disconnect a currently connected wearable device and connect another wearable device to the mobile device 312, the application backend 326 handles the switch by performing a SIM swap. The application backend 326 determines if the unique identifier associated with the wearable device that the user is attempting to connect to the mobile device 312 exists in the stored data. Upon confirming the unique identifier exists in the stored data, the application backend 326 performs the SIM swap such that the MSISDN of the mobile device is disassociated with the currently connected wearable device and is associated with the unique identifier of the newly connected wearable device and subsequently connects the wearable device to the mobile device 312.

The application backend 326 includes the integration service 328 that performs a broad range of data migration tasks to integrate data among the wearable devices 332A-D after successful connection of a wearable device to the mobile device 312. The integrated data can include usage data associated with each of the wearable devices 332A-D, status of each of the wearable devices 332A-D, or data stored in the mobile device 312 such as emergency contact information and messages including short messaging service (SMS) messages, system messages, or voice messages.

The mobile application 322 is configured to communicate with various components 302 of a telecommunications network. The components 302 include web services gateway 304, business support system 306, network application processor 308, and subscriber event listener 310. Other implementations may include more or less network components, depending on the type of communications between the telecommunications network and the mobile application 322.

The web services gateway 304 provides a single point of control, access, and validation of web service requests and stores pairing events between mobile devices and wearable devices in the telecommunications network.

The business support system 306 refers to a set of software programs that allow the telecommunications network to manage and streamline activities of subscribers, including billing events associated with the mobile application 322. The network application processor 308 receives billing events from the mobile application 322 and forwards the billing events to the business support system 306. The subscriber event listener 310 is a function that waits for a specific subscriber event, such as a request to purchase or a request to retrieve data from the telecommunications network, to occur and performs an appropriate action in response to triggering of the subscriber event.

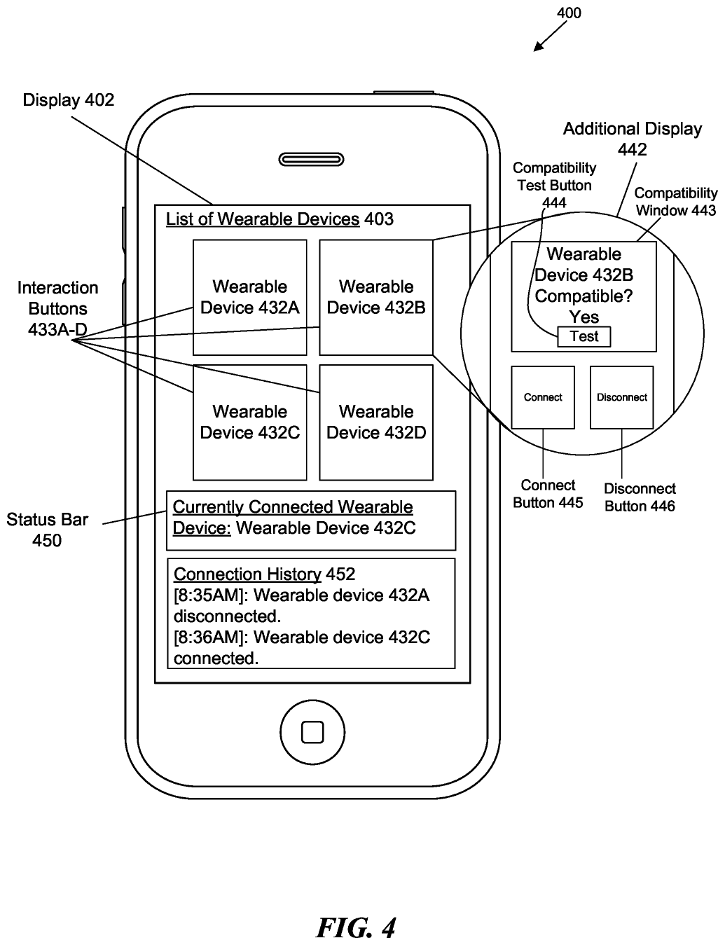

FIG. 4 illustrates an example display of the mobile application, according to an implementation of the present technology. A mobile device 400, such as a mobile phone, enables a user to access the mobile application to manage connections between the mobile device and multiple wearable devices. The display 402 can include a list of wearable devices 403, a status bar 450, and a connection history 452.

The list of wearable devices 403 displays wearable devices 432A-D available for connection with the mobile device 400. In some implementations, the user is enabled to personalize the names of the wearable devices for convenience. For example, the user can rename wearable device 432D as Red Apple Watch 6 to indicate the color and make of the wearable device. In some implementations, the list of wearable devices 403 displays interaction buttons 433A-D, each associated with a respective wearable device of the wearable devices 432A-D. Upon an input from the user indicating interaction with one of the interaction buttons 433A-D, an additional display 442 can pop up to display more information of the associated wearable device.

For example, upon pressing interaction button 433B associated with the wearable device 432B, the mobile application is configured to display additional display 442 associated with the wearable device 432B. The additional display 442 includes compatibility window 443, which includes information regarding compatibility of the wearable device 432B with the mobile device 400. In some implementations, the compatibility window 443 includes a compatibility test button 444 to enable the user to check for up-to-date compatibility requirements. The additional display 442 further includes a connect button 445 to connect the wearable device 432B to the mobile device. The additional display 442 can also include a disconnect button 446 to disconnect the wearable device 432B from the mobile device.

The status bar 450 displays a wearable device currently connected to the mobile device. As shown in FIG. 4, the wearable device currently connected to the mobile device 400 is the wearable device 432C. In some implementations, the status bar 450 includes more information regarding the currently connected wearable device, such as message forwarding settings and status of data updates for the currently connected wearable device.

The connection history 452 displays a record of connections between the mobile device and the wearable devices. As shown in FIG. 4, in some implementations, each entry in the connection history 452 can include a timestamp of when a connection or a disconnection event occurred.

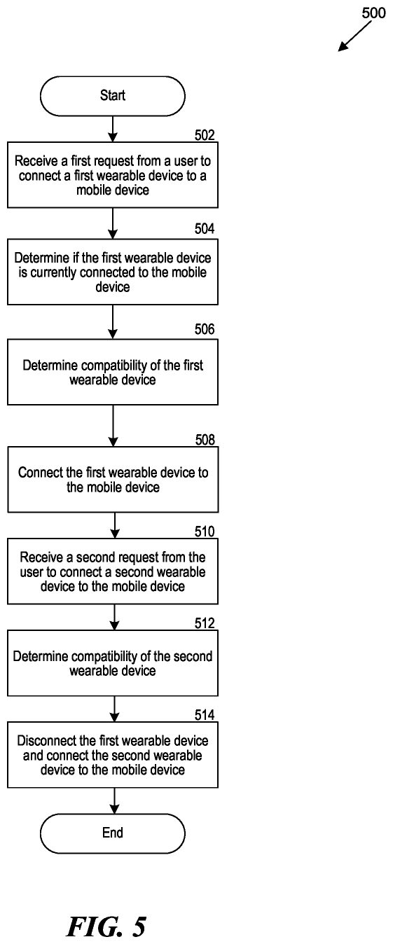

FIG. 5 is a flowchart representation of a system 500 of managing and switching connections between a mobile device and multiple wearable devices according to some implementations of the present technology. At 502, the system receives a first request from a user to connect a first wearable device to the mobile device. The mobile device is associated with a unique MSISDN, and the first wearable device is associated with a unique identifier, such as an eSIM. Alternatively, the unique identifier can be a physical SIM inserted into the first wearable device. The first request can be the user selecting the first wearable device for connection on a mobile application of the mobile device. The first request to connect the first wearable device to the mobile device can also be made by the user by interacting with the first wearable device, such as pressing a button on the first wearable device to connect to the mobile device.

In some implementations, the system stores a list of unique identifiers of multiple wearable devices associated with the mobile device and dynamically updates the list. For example, upon determining that a wearable device is no longer associated with the mobile device, the system removes a unique identifier associated with the wearable device from the list of unique identifiers of multiple wearable devices. The system can be configured to send a system notification to the user of the disassociation of the wearable device.

At 504, the system determines if the first wearable device is currently connected to the mobile device. Upon determining that the first wearable device is not connected to the mobile device, at 506, the system determines compatibility of the first wearable device with the mobile device.

Upon determining that the first wearable device is compatible with the mobile device, at 508, the system connects the first wearable device to the mobile device. In some implementations, upon connecting the first wearable device to the mobile device, the system starts forwarding messages from the mobile device to the first wearable device. The messages can include SMS messages, system messages, or voice messages associated with the mobile device. In addition to the forwarding of messages, the system can be configured to migrate stored messages to the first wearable device to enable the user to access the stored messages using the first wearable device.

In some implementations, upon successful connection of the first wearable device to the mobile device, the system updates data of the first wearable device. The updated data can include data stored in the mobile device, such as a contact list including emergency contact information, messages associated with the mobile device, and usage data of other wearable devices associated with the mobile device.

At 510, the system receives a second request from the user to connect a second wearable device to the mobile device. The second wearable device is associated with a unique identifier different from the unique identifier associated with the first wearable device. The second request can be the user selecting the second wearable device for connection on the mobile application of the mobile device. In some implementations, upon receiving the second request from the user, the system sends a request to the mobile device for authentication of the second request. The authentication request can be a system message within the mobile application of the mobile device or an SMS message sent to the mobile device.

Prior to disconnecting the first wearable device, the system, at 512, determines compatibility of the second wearable device. At 514, the system disconnects the first wearable device and connects the second wearable device to the mobile device upon determining that the second wearable device is compatible with the mobile device. Upon disconnecting the second wearable device from the mobile device, the system can be configured to stop forwarding messages from the mobile device to the first wearable device. Additionally, the system starts forwarding messages from the mobile device to the second wearable device.

In some implementations, upon disconnecting the first wearable device and connecting the second wearable device to the mobile device, the system sends a notification to the user of the newly established connection. The notification can be a system message within the mobile application or an SMS message to the mobile device. Additionally or alternatively, the notification can be sent to either or both of the first wearable device and the second wearable device.

In some implementations, upon successful connection of the second wearable device to the mobile device, the system updates data of the second wearable device. The updated data can include data stored in the mobile device, such as a contact list including emergency contact information, messages associated with the mobile device, and usage data of other wearable devices, including the first wearable device, associated with the mobile device. For example, depending on data compatibility, healthcare information gathered and stored in the first wearable device is migrated to the second wearable device upon connection of the second wearable device to enable the user to access healthcare information gathered when the user was using the first wearable device.

In other implementations, the system stores in a memory a list of multiple wearable devices associated with the mobile device. The system is configured to track locations of the wearable devices in the list of wearable devices. Locations of the wearable devices can be tracked if the wearable devices are connected via wireless technologies, including but not limited to Bluetooth and Wi-Fi networks. In an example, tracked locations of the wearable devices can be used to detect a wearable device that is located outside of a geofence associated with the user's household. Based on the detection, the system can identify the wearable device located outside of the geofence from the list of multiple wearable devices associated with the mobile device. Upon determining that the wearable device located outside of the geofence is not connected to the mobile device, the system can send a notification to the user. The notification can include location information of the wearable device. The notification can also include an inquiry whether the user would like to connect the wearable device to the mobile device. In some implementations, the system is configured to automatically establish connection between the wearable device and the mobile device and start forwarding messages from the mobile device to the wearable device.

### Computer System

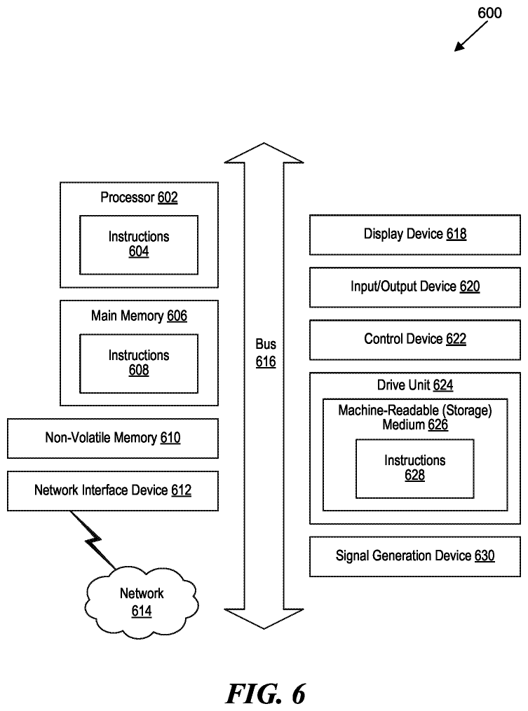

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, a video display device 618, an input/output device 620, a control device 622 (e.g., keyboard and pointing device), a drive unit 624 that includes a machine-readable (storage) medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computing system 600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 600. In some implementations, the computer system 600 can be an embedded computer system, a system-on-chip (SOC), a single-board computer system (SBC), or a distributed system such as a mesh of computer systems, or it can include one or more cloud components in one or more networks. Where appropriate, one or more computer systems 600 can perform operations in real time, in near real time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A non-transitory, computer-readable storage medium comprising instructions to manage connections between a mobile device and one or more wearable devices, wherein the instructions, when executed by at least one data processor of a system, cause the system to:
receive a first request from a user to connect a first wearable device to the mobile device,
wherein the first wearable device is associated with a unique identifier,
wherein the mobile device is associated with a unique mobile station international subscriber directory number (MSISDN), and
wherein the mobile device is associated with the one or more wearable devices;
determine if the first wearable device is currently connected to the mobile device;
upon determining the first wearable device is not connected to the mobile device, determine compatibility of the first wearable device;
upon determining that the first wearable device is compatible with the mobile device, connect the first wearable device to the mobile device;
receive a second request from the user to connect a second wearable device to the mobile device,
wherein the second wearable device is associated with a unique identifier different from the first wearable device;
determine compatibility of the second wearable device; and
upon determining that the second wearable device is compatible with the mobile device, disconnect the first wearable device and connect the second wearable device to the mobile device.

2. The non-transitory, computer-readable storage medium of claim 1, wherein the instructions further cause the system to:
upon connecting the first wearable device to the mobile device, start forwarding messages from the mobile device to the first wearable device,
wherein the messages include at least one of: short messaging service (SMS) messages, system messages, or voice messages;
upon disconnecting the first wearable device from the mobile device, stop forwarding the messages to the first wearable device; and
upon connecting the second wearable device to the mobile device, start forwarding the messages from the mobile device to the second wearable device.

3. The non-transitory, computer-readable storage medium of claim 1, wherein the instructions further cause the system to:
store, in a memory, a list of wearable devices associated with the mobile device;
track location of the wearable devices in the list of wearable devices;
receive an indication that the location of a wearable device is outside of a geofence associated with the user's household;
upon receiving the indication, identify, from the list of wearable devices associated with the mobile device, the wearable device that is located outside of the geofence associated with the user's household; and
automatically start forwarding messages from the mobile device to the wearable device,
wherein the messages include at least one of: SMS messages, system messages, or voice messages.

4. The non-transitory, computer-readable storage medium of claim 1, wherein the first request from the user comprises the user selecting the first wearable device on a mobile application of the mobile device, and wherein the second request from the user comprises the user selecting the second wearable device on the mobile application of the mobile device.

5. The non-transitory, computer-readable storage medium of claim 1, wherein the instructions further cause the system to:
upon receiving the second request from the user, send a request to the mobile device for authentication of the second request.

6. The non-transitory, computer-readable storage medium of claim 1, wherein the instructions further cause the system to:
upon disconnecting the first wearable device and connecting the second wearable device to the mobile device, send a notification to the user of the new connection.

7. The non-transitory, computer-readable storage medium of claim 1, wherein the unique identifier is an embedded SIM (eSIM) installed in each wearable device.

8. The non-transitory, computer-readable storage medium of claim 1, wherein the instructions further cause the system to:
upon disconnecting the first wearable device and connecting the second wearable device to the mobile device, update data of the second wearable device,
wherein the updated data includes at least one of: usage data associated with the first wearable device, emergency contact information, SMS messages, or status of the one or more wearable devices associated with the mobile device.

9. The non-transitory, computer-readable storage medium of claim 1, wherein the instructions further cause the system to:
when a wearable device is no longer associated with the mobile device, send a notification to the user of the disassociation.

10. A system comprising:
at least one hardware processor; and
at least one non-transitory memory storing instructions to manage connections between a mobile device and one or more wearable devices, which, when executed by the at least one hardware processor, cause the system to:
receive a first request from a user to connect a first wearable device to the mobile device,
wherein the first wearable device is associated with a unique identifier,
wherein the mobile device is associated with a unique number, and
wherein the mobile device is associated with the one or more wearable devices;
determine if the first wearable device is currently connected to the mobile device;
upon determining that the first wearable device is not connected to the mobile device, connect the first wearable device to the mobile device;
receive a second request from the user to connect a second wearable device to the mobile device,
wherein the second wearable device is associated with a unique identifier different from the first wearable device; and
disconnect the first wearable device and connect the second wearable device to the mobile device.

11. The system of claim 10, wherein the instructions further cause the system to:
upon connecting the first wearable device to the mobile device, start forwarding messages from the mobile device to the first wearable device,
wherein the messages include at least one of: short messaging service (SMS) messages, system messages, or voice messages;
upon disconnecting the first wearable device from the mobile device, stop forwarding the messages to the first wearable device; and
upon connecting the second wearable device to the mobile device, start forwarding the messages from the mobile device to the second wearable device.

12. The system of claim 10, wherein the instructions further cause the system to:
store, in a memory, a list of wearable devices associated with the mobile device;
track location of the wearable devices in the list of wearable devices;
receive an indication that the location of a wearable device is outside of a geofence associated with the user's household;
upon receiving the indication, identify, from the list of wearable devices associated with the mobile device, the wearable device that is located outside of the geofence associated with the user's household; and
automatically start forwarding messages from the mobile device to the wearable device,
wherein the messages include at least one of: SMS messages, system messages, or voice messages.

13. The system of claim 10, wherein the first request from the user comprises the user selecting the first wearable device on a mobile application of the mobile device, and wherein the second request from the user comprises the user selecting the second wearable device on the mobile application of the mobile device.

14. The system of claim 10, wherein the instructions further cause the system to:
upon receiving the second request from the user, send a request to the mobile device for authentication of the second request.

15. The system of claim 10, wherein the instructions further cause the system to:
upon disconnecting the first wearable device and connecting the second wearable device to the mobile device, send a notification to the user of the new connection.

16. The system of claim 10, wherein the unique identifier is an embedded SIM (eSIM) installed in each wearable device.

17. The system of claim 10, wherein the instructions further cause the system to:
upon disconnecting the first wearable device and connecting the second wearable device to the mobile device, update data of the second wearable device,
wherein the updated data includes at least one of: usage data associated with the first wearable device, emergency contact information, SMS messages, or status of the one or more wearable devices associated with the mobile device.

18. A method comprising:
receiving a first request from a user to connect a first wearable device to a mobile device,
wherein the first wearable device is associated with a unique identifier,
wherein the mobile device is associated with a unique number, and
wherein the mobile device is associated with one or more wearable devices;
connecting the first wearable device to the mobile device;
receiving a second request from the user to connect a second wearable device to the mobile device,
wherein the second wearable device is associated with a unique identifier different from the first wearable device; and
disconnecting the first wearable device and connecting the second wearable device to the mobile device.

19. The method of claim 18, further comprising:
upon connecting the first wearable device to the mobile device, starting forwarding of messages from the mobile device to the first wearable device,
wherein the messages include at least one of: short messaging service (SMS) messages, system messages, or voice messages;
upon disconnecting the first wearable device from the mobile device, stopping forwarding of the messages to the first wearable device; and
upon connecting the second wearable device to the mobile device, starting forwarding of the messages from the mobile device to the second wearable device.

20. The method of claim 18, further comprising:
storing, in a memory, a list of wearable devices associated with the mobile device;
tracking location of the wearable devices in the list of wearable devices;
receiving an indication that the location of a wearable device is outside of a geofence associated with the user's household;
upon receiving the indication, identifying, from the list of wearable devices associated with the mobile device, the wearable device that is located outside of the geofence associated with the user's household; and
automatically starting forwarding of messages from the mobile device to the wearable device,
wherein the messages include at least one of: SMS messages, system messages, or voice messages.
